(19) United States
(12) Patent Application Publication
(10) Pub. No.: US 2026/0109019 A1
(43) Pub. Date: Apr. 23, 2026

(54) PEGBOARD HOLDER

(71) Applicant: Walter R. Tucker Enterprises, Ltd. D/B/A E-Z Red Company, Deposit, NY (US)

(72) Inventor: Robert CACCIABEVE, Denville, NJ (US)

(73) Assignee: Walter R. Tucker Enterprises, Ltd. D/B/A E-Z Red Company, Deposit, NY (US)

(21) Appl. No.: 19/367,353

(22) Filed: Oct. 23, 2025

Related U.S. Application Data
(60) Provisional application No. 63/710,776, filed on Oct. 23, 2024.

(51) Int. Cl. B25H 3/04; B25H 3/06; F16M 13/02

(52) U.S. Cl. CPC B25H 3/04; B25H 3/06; F16M 13/022

(57) ABSTRACT

There is disclosed a pegboard holder for use in a pegboard for holding items such as tools. The pegboard holder is such that it may be compressed to lock into a pegboard and unlock from the pegboard. The pegboard holder includes a base, a support, one or more upper inflexible tabs and one or more lower flexible tabs. The upper and lower tabs extend from the base and are adapted to fit into a pegboard hole. The flexible tab may flex up and down to fit into holes in the pegboard and lock into, and unlock from the pegboard. The tabs may include one or more detents to allow the pegboard holder to fit into pegboards of different thicknesses.

### RELATED APPLICATION

This application claims the benefit of U.S. Provisional Application Ser. No. 63/710,776, filed Oct. 23, 2024, entitled “Pegboard Hook,” which is incorporated herein by reference in its entirety

### FIELD OF THE INVENTION

The present invention relates to a pegboard holder. More particularly, the invention relates to a pegboard holder that allows the holder to lock into, and unlock from a pegboard. The pegboard holder can be configured to hold different types of tools, including on pegboards having different thicknesses.

### BACKGROUND OF THE INVENTION

Pegboards are used in various professions for holding items. In automotive garages and the like, pegboards are used to hold tools and related items. The pegboards include a pegboard holder inserted into the pegboard to hold the tool or item. The known pegboard holders are usually of metal and hang loose in the pegboard holes receiving the holder. The pegboard holder may not lock into place in the pegboard.

These known pegboard holders have various shortcomings. These and other shortcomings are addressed by the present invention.

### SUMMARY OF THE INVENTION

The invention is directed to a pegboard holder.

An object of the invention is to provide a pegboard holder having compression and material properties allowing the pegboard holder to lock into a user's pegboard.

Another object of the invention is to provide a pegboard holder having one or more flexible tabs enabling locking and unlocking of the pegboard holder into and from the pegboard.

Another object of the invention is to provide a pegboard holder having one or more upper inflexible tabs and one or more lower flexible tabs to lock into the pegboard, thereby allowing the holder to be used with pegboards having different thicknesses.

Another object of the invention is to provide a pegboard holder having one or more upper inflexible tabs and one or more lower flexible tabs and configured to hold different items, including tools.

Another object of the invention is to provide a pegboard holder having one or more upper inflexible tabs and one or more lower flexible tabs extending from a base of the holder, wherein the inflexible tab is first inserted into a pegboard and holds the weight of the holder with the held item and the flexible tab is thereafter inserted into the pegboard to lock and unlock the holder from the pegboard.

Another object of the invention is to provide a pegboard holder having one or more upper inflexible tabs and one or more lower flexible tabs extending from a base of the holder, wherein the upper inflexible tabs extend outwardly and upwardly from the base and have one or more detents for engaging the back of the pegboard and the one or more lower flexible tabs extend outwardly from the base and have one or more detents for engaging the back of the pegboard.

The invention is directed to a pegboard holder having one or more upper inflexible tabs for attaching to the pegboard and one or more lower flexible tabs for attaching to the pegboard. The upper inflexible tab is adapted to attach to the pegboard in two or more locations, preferably three locations, for attachment to pegboards having different thicknesses. The lower flexible tab is adapted to attach to the pegboard in two or more locations, preferably in three locations, for attachment to pegboards having different thicknesses. The pegboard holder is configured to hold different items, including tools.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1 is a front and side perspective view of the pegboard holder of the invention configured to function as a hook.

FIG. 2 is a back and side perspective view of FIG. 1.

FIG. 3 is a front view of FIG. 1.

FIG. 4 is a back view of FIG. 1.

FIG. 5 is a side view of FIG. 1.

FIG. 6 is a top view of FIG. 1.

FIG. 7 is a bottom view of FIG. 1.

FIG. 8A is a side view of FIG. 1.

FIG. 8B is an enlarged view of section 8B of FIG. 8A.

FIG. 8C is an enlarged view of section 8C of FIG. 8A.

FIG. 9A shows the pegboard holder of FIG. 1 attached to a thin metal pegboard.

FIG. 9B is a cross-sectional view taken along line 9B-9B of FIG. 9A.

FIG. 9C is an enlarged view of section 9C of FIG. 9B.

FIG. 10A shows the pegboard holder of FIG. 1 attached to an indented metal pegboard.

FIG. 10B is a cross-sectional view taken along line 10B-10B of FIG. 10A.

FIG. 10C is an enlarged view of section 10C of FIG. 10B.

FIG. 11A shows the pegboard holder of FIG. 1 attached to a thick fiber or plastic pegboard.

FIG. 11B is a cross-sectional view taken along line 11B-11B of FIG. 11A.

FIG. 11C is an enlarged view of section 11C of FIG. 11B.

FIG. 12A is a front and side perspective view of the pegboard holder of the invention for holding wrenches or the like.

FIG. 12B is a back and side perspective view of FIG. 12A.

FIG. 12C is a front view of FIG. 12A.

FIG. 12D is a back view of FIG. 12A.

FIG. 12E is a side view of FIG. 12A.

FIG. 12F is a top view of FIG. 12A.

FIG. 12G is a cross-sectional view taken along line 12G-12G of FIG. 12C.

FIG. 13A is a front and side perspective view of the pegboard holder of the invention for holding a spray can, bottle or the like.

FIG. 13B is a back and side perspective view of FIG. 13A.

FIG. 13C is a front view of FIG. 13A.

FIG. 13D is a back view of FIG. 13A.

FIG. 13E is a side view of FIG. 13A.

FIG. 13F is a top view of FIG. 13A.

FIG. 13G is a cross-sectional view taken along line 13G-13G of FIG. 13C.

FIG. 14A is a front and side perspective view of the pegboard holder of the invention having multiple compartments for holding pencils, tools or the like.

FIG. 14B is a back and side perspective view of FIG. 14A.

FIG. 14C is a front view of FIG. 14A.

FIG. 14D is a back view of FIG. 14A.

FIG. 14E is a side view of FIG. 14A.

FIG. 14F is a top view of FIG. 14A.

FIG. 14G is a cross-sectional view taken along line 14G-14G of FIG. 14D.

FIG. 15A is a front and side perspective view of the pegboard holder of the invention for holding screwdrivers.

FIG. 15B is a back and side perspective view of FIG. 15A.

FIG. 15C is a front view of FIG. 15A.

FIG. 15D is a back view of FIG. 15A.

FIG. 15E is a side view of FIG. 15A.

FIG. 15F is a cross-sectional view taken along line 15F-15F of FIG. 15D.

FIG. 16A is a front and side perspective view of the pegboard holder of the invention for holding screwdrivers.

FIG. 16B is a back and side perspective view of FIG. 16A.

FIG. 16C is a front view of FIG. 16A.

FIG. 16D is a back view of FIG. 16A.

FIG. 16E is a side view of FIG. 16A.

FIG. 16F is a cross-sectional view taken along line 16F-16F of FIG. 16C.

FIG. 17A is a front and side perspective view of the pegboard holder of the invention for holding a parts tray.

FIG. 17B is a back and side perspective view of FIG. 17A.

FIG. 17C is a front view of FIG. 17A.

FIG. 17D is a back view of FIG. 17A.

FIG. 17E is a side view of FIG. 17A.

FIG. 17F is a top view of FIG. 17A.

FIG. 17G is a cross-sectional view taken along line 17G-17G of FIG. 17C.

FIG. 18A is a front and side perspective view of the pegboard holder of the invention for holding pliers or the like.

FIG. 18B is a back and side perspective view of FIG. 18A.

FIG. 18C is a front view of FIG. 18A.

FIG. 18D is a back view of FIG. 18A.

FIG. 18E is a side view of FIG. 18A.

FIG. 18F is a top view of FIG. 18A.

FIG. 18G is a cross-sectional view taken along line 18G-18G of FIG. 18C.

FIG. 19 shows the pegboard holders of FIGS. 1-18 in use on a pegboard.

### DETAILED DESCRIPTION OF THE PREFERRED EMBODIMENTS

The present invention is directed to a pegboard holder for use in a pegboard for holding items such as tools or related items used in an automotive garage or the like. The pegboard holder is made of plastic such as, but not limited to, ABS plastic (acrylonitrile butadiene styrene). Preferably, the holder is made in a mold. The pegboard holder is such that it may be compressed to lock into a pegboard and unlock from the pegboard.

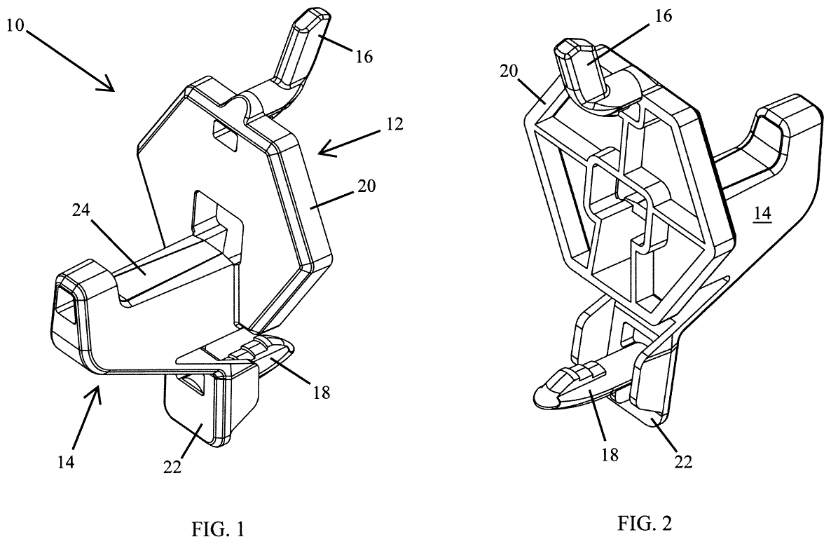

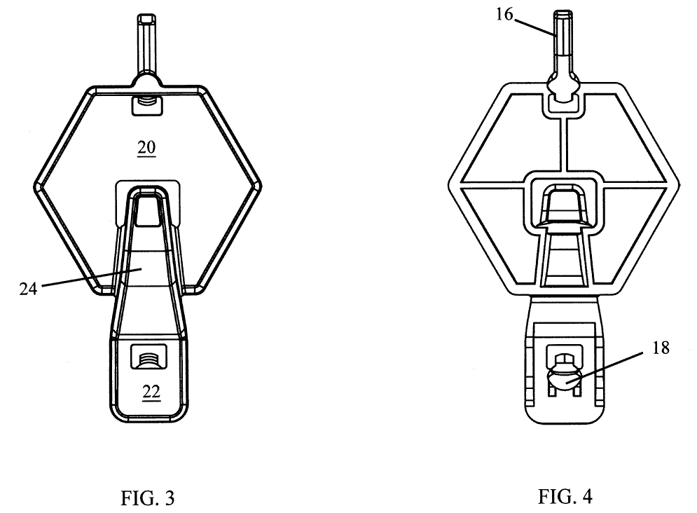

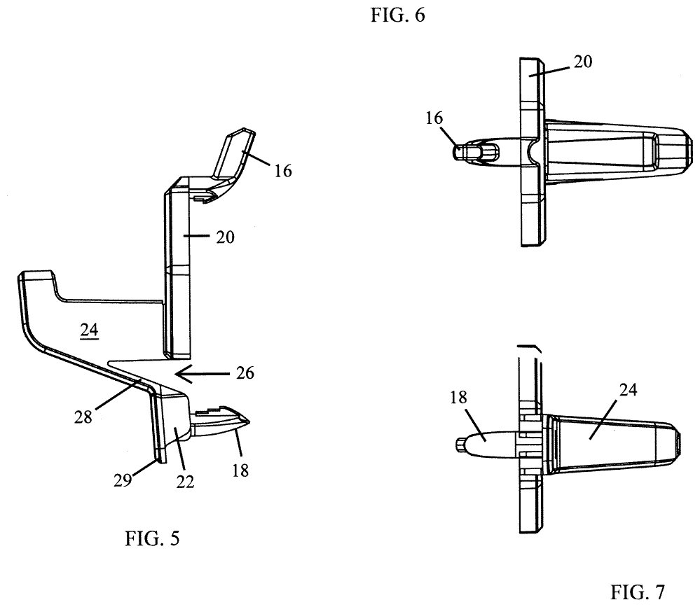

More specifically, referring to FIGS. 1-11, the pegboard holder 10 comprises a base 12, a support 14 for holding an item and one or more upper inflexible tabs 16 and one or more lower flexible tabs. Inflexible tab 16 extends from a top portion of base 12 and is adapted to fit into a pegboard hole. Lower flexible tab 18 extends from a bottom portion of base 12 and is adapted to fit into a pegboard hole. The inflexible tab 16 is first inserted into a peg hole of the pegboard and will hold the weight of the holder and the held item. The flexible tab 18 may flex up and down to fit into a hole in the pegboard and lock into, and unlock from the pegboard. Preferably, the inflexible and flexible tabs include one or more detents adapted to lock the pegboard holder into pegboards of different thicknesses. Preferably, the upper inflexible tab 16 extends outwardly and upwardly from base 12 and lower flexible tab 18 extends outwardly from base 12.

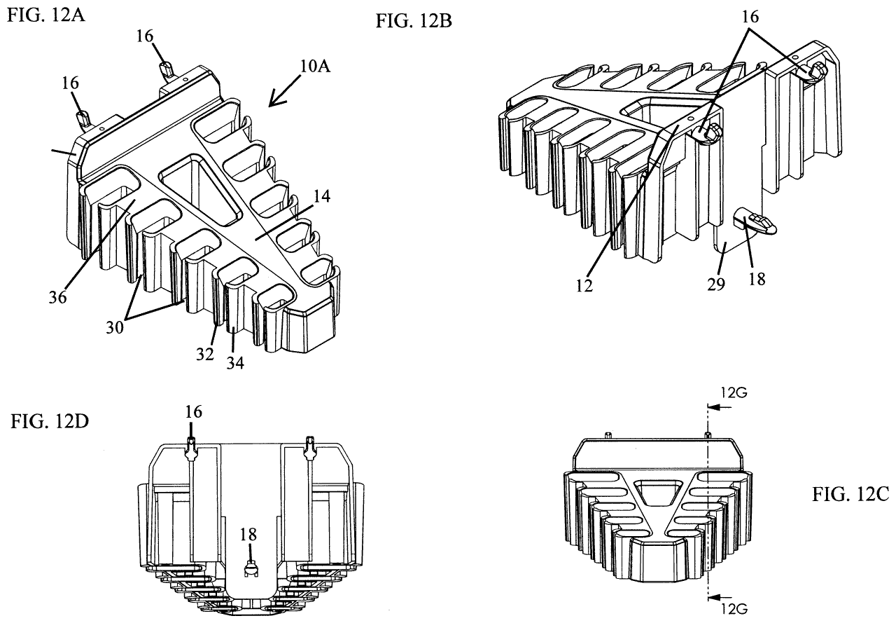

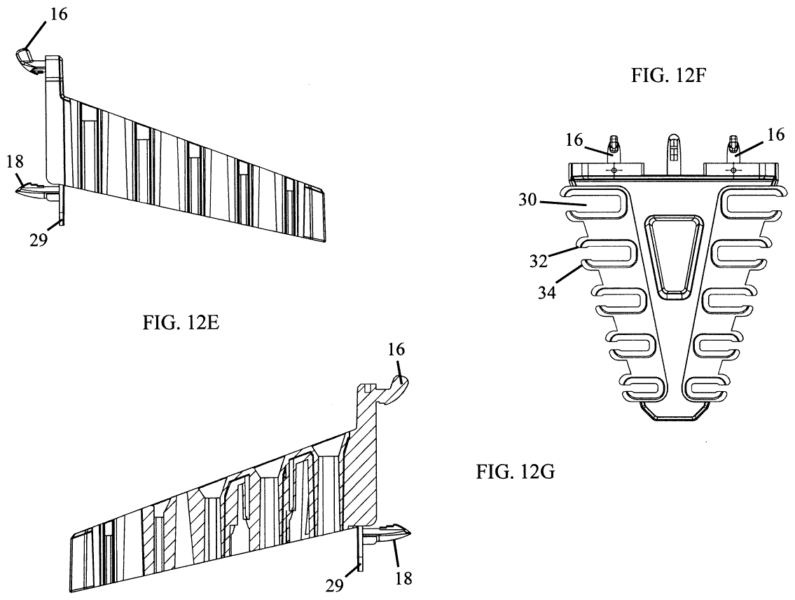

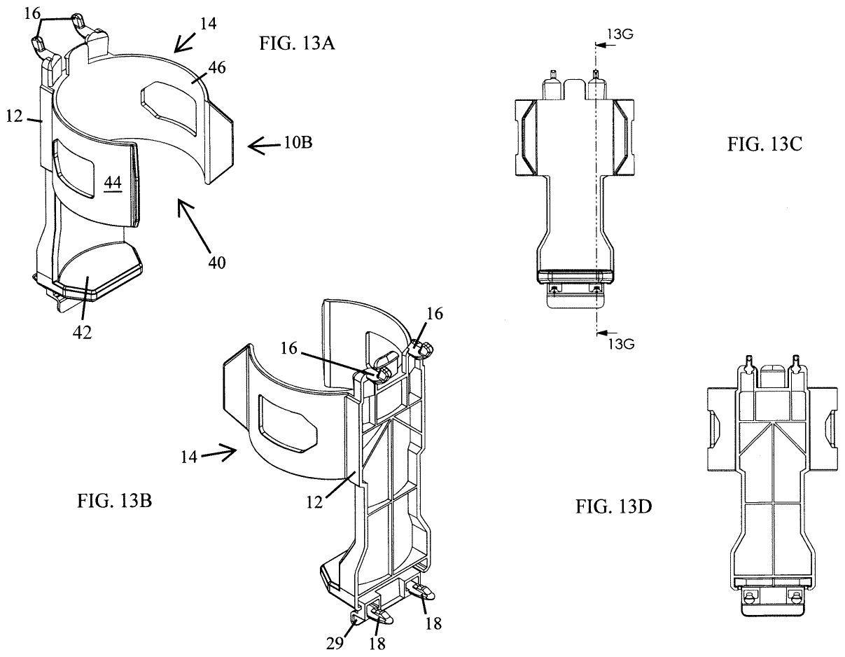

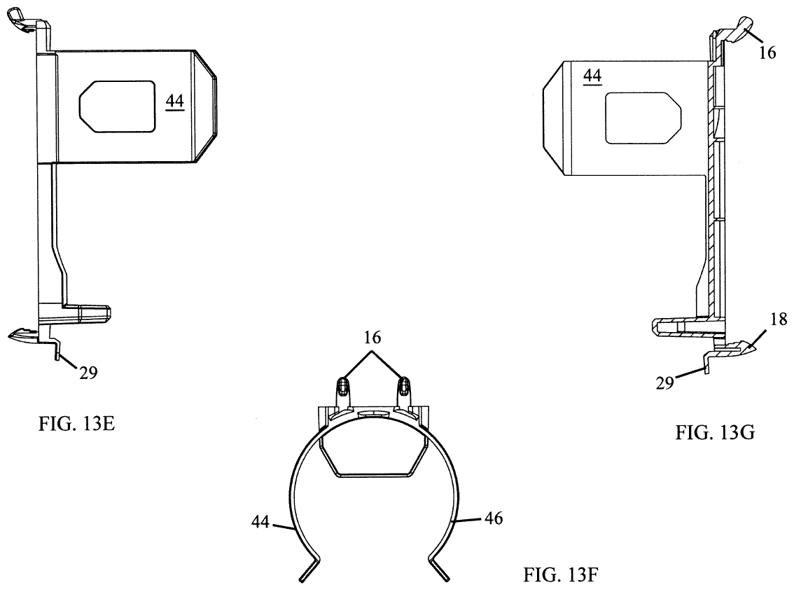

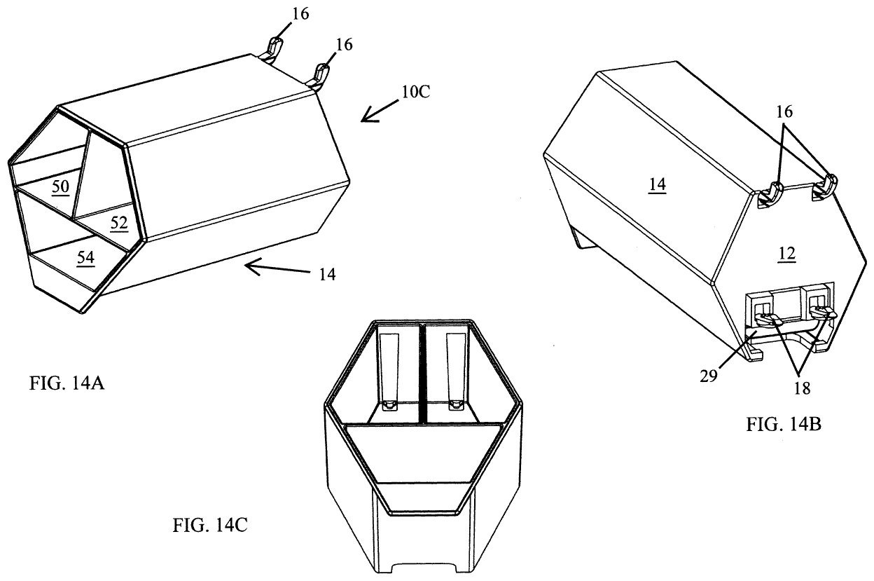

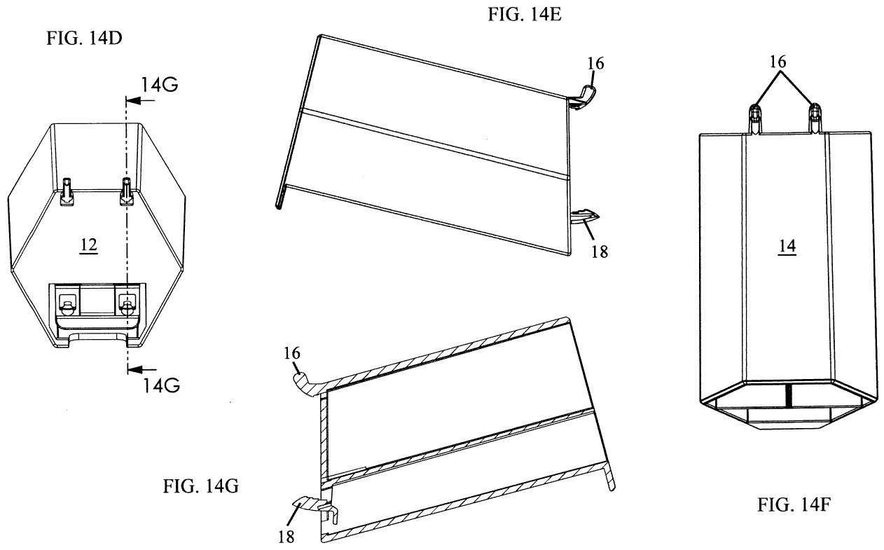

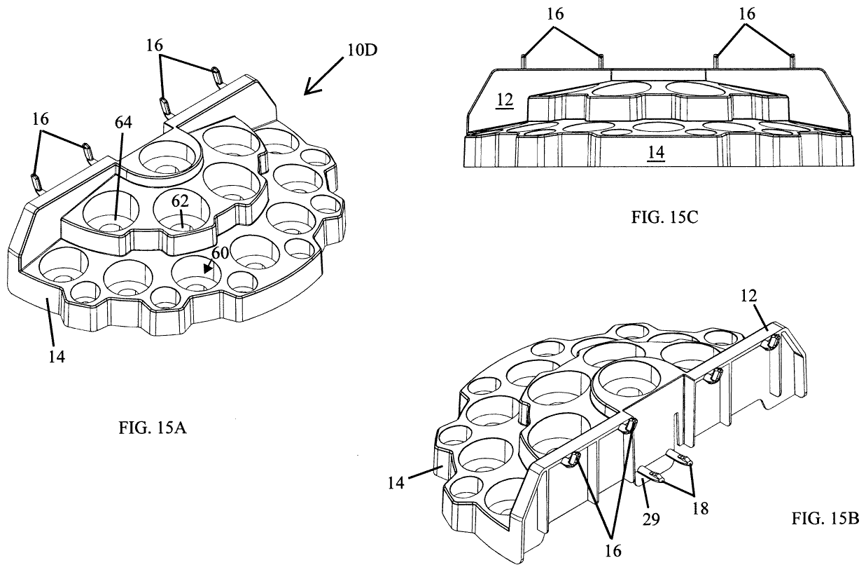

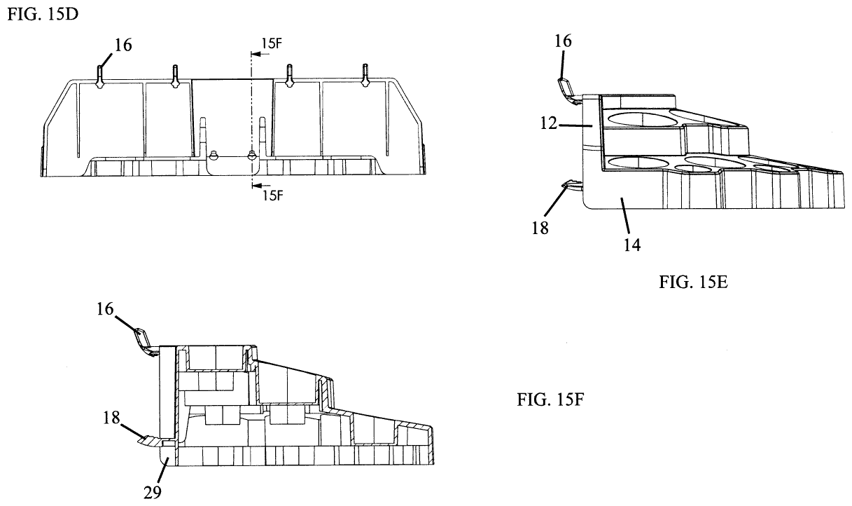

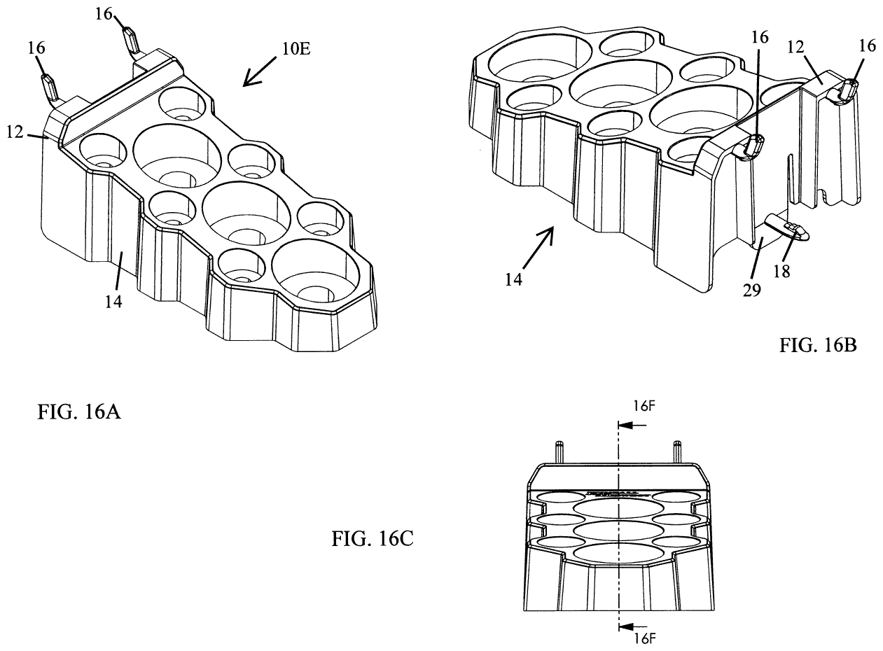

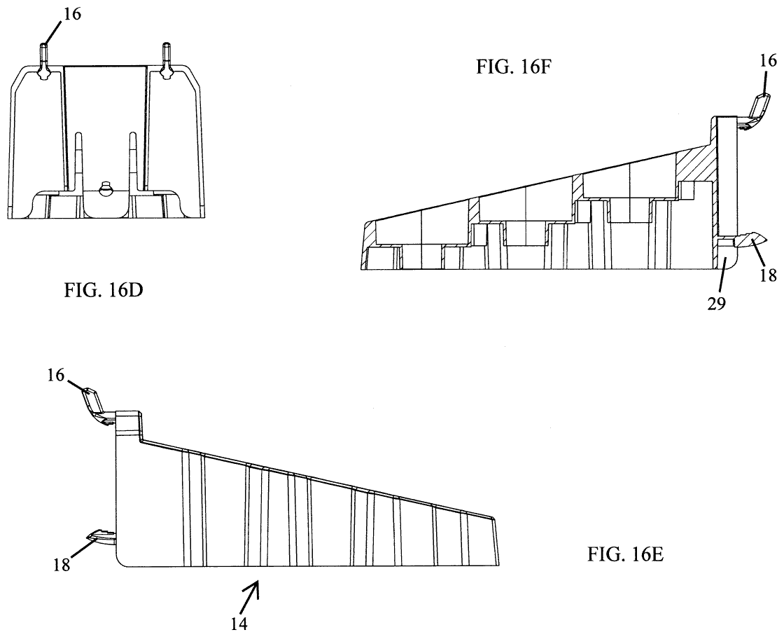

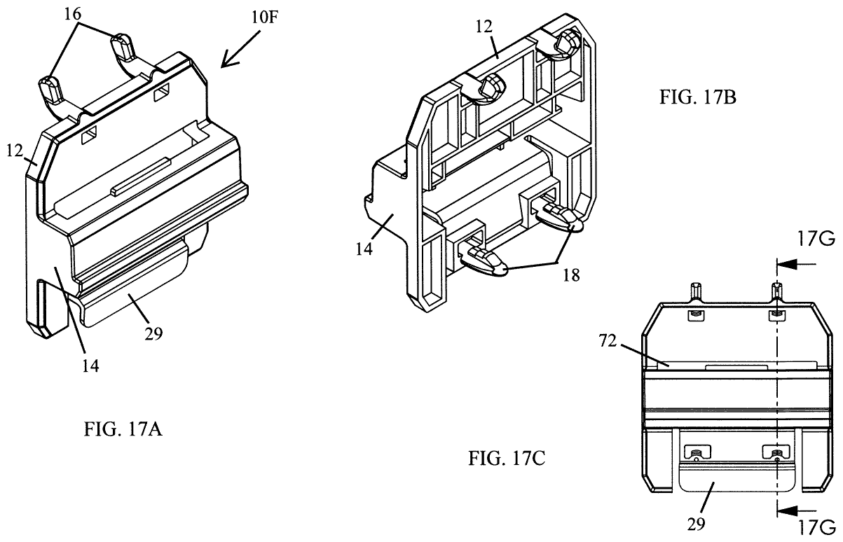

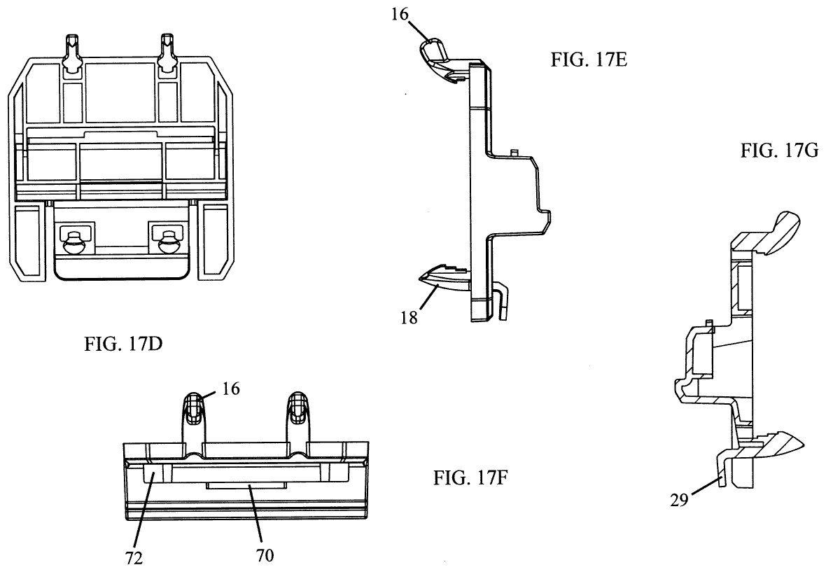

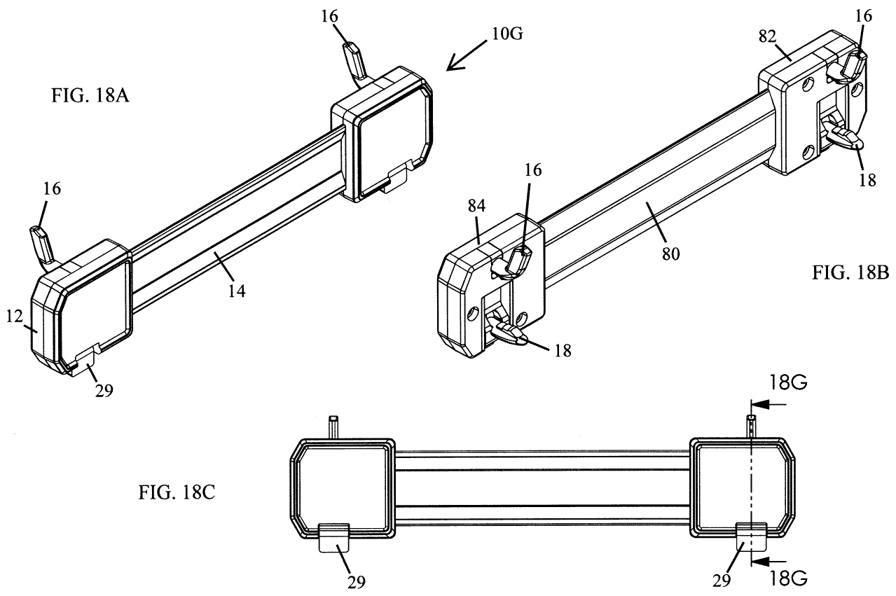

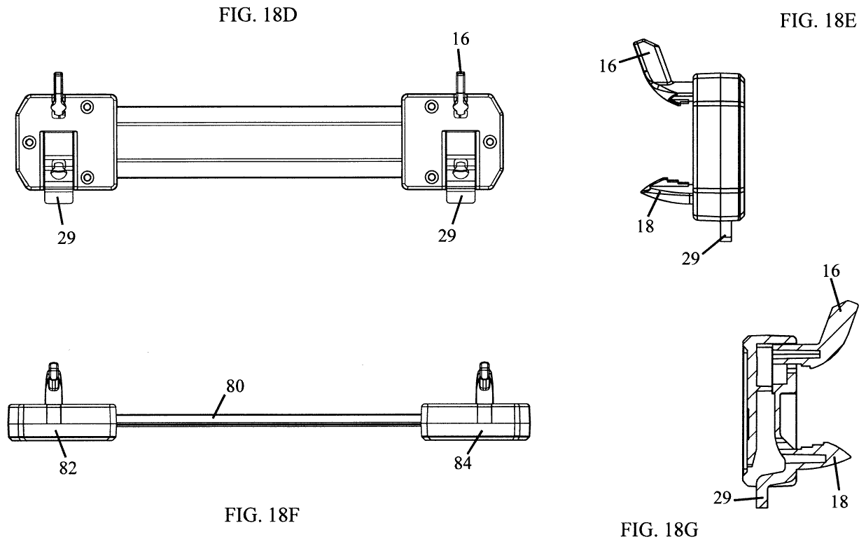

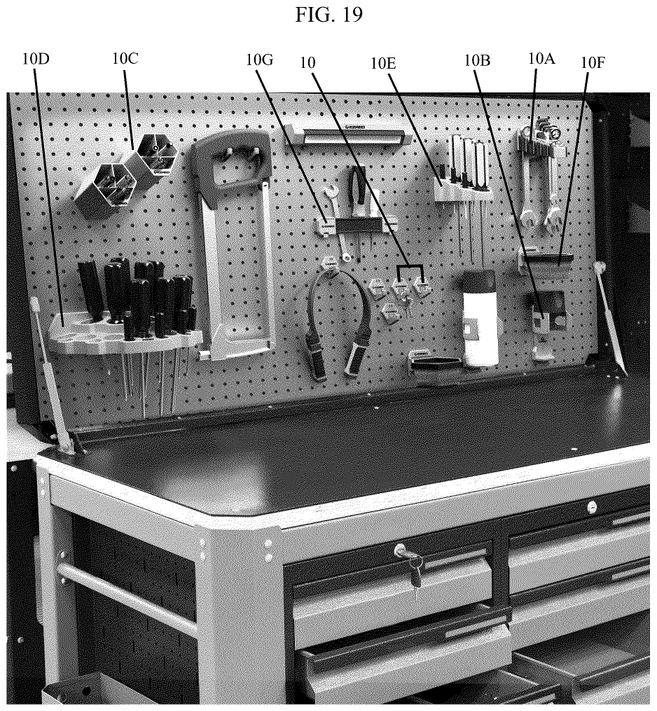

The pegboard holder 10 may be used for holding different size tools. For example, FIGS. 1-11 show a pegboard holder having a hook for holding items such as a key chain, lanyard, a neck light or the like. FIG. 12 shows a pegboard holder for holding wrenches. FIG. 13 shows a pegboard holder for holding a spray can, bottle or the like. FIG. 14 shows a pegboard holder having compartments for holding pencils, tools or the like. FIG. 15 shows a pegboard holder for holding screwdrivers. FIG. 16 is similar to FIG. 15 and shows a smaller pegboard holder for holding screwdrivers. FIG. 17 shows a pegboard holder for holding a parts tray. FIG. 18 shows a pegboard holder for holding pliers, wrenches, screwdrivers or the like. It is understood that the pegboard holder may be configured and used for holding other types of tools or items.

Referring to FIGS. 1-18, each of the pegboard holders include a base 12 having one or more upper inflexible tabs 16 and one or more lower flexible tabs 18. The base 12 includes a support 14 of different configurations for holding different types of tools or items. The one or more upper and lower tabs 16 and 18 are the same for each of the pegboards shown in FIGS. 1-18.

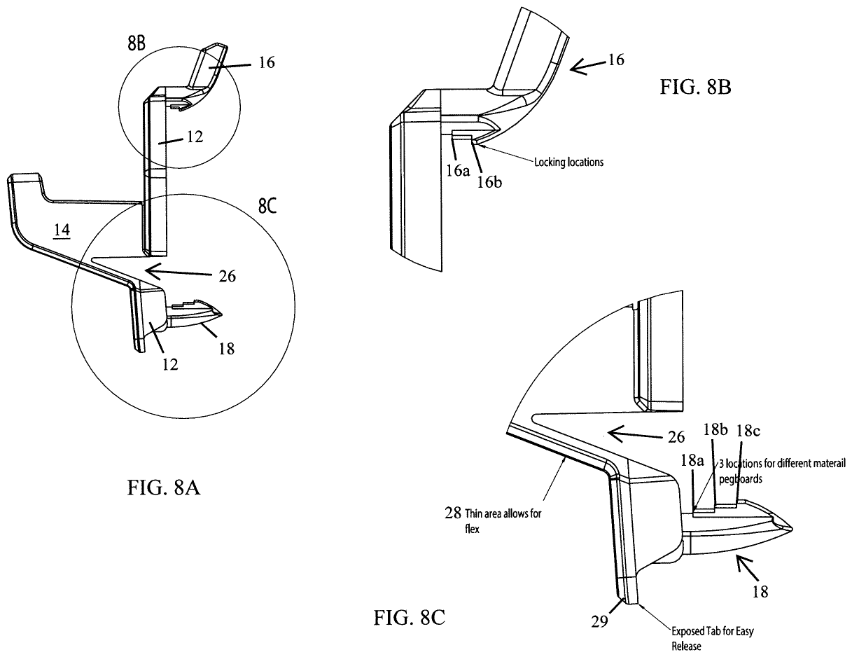

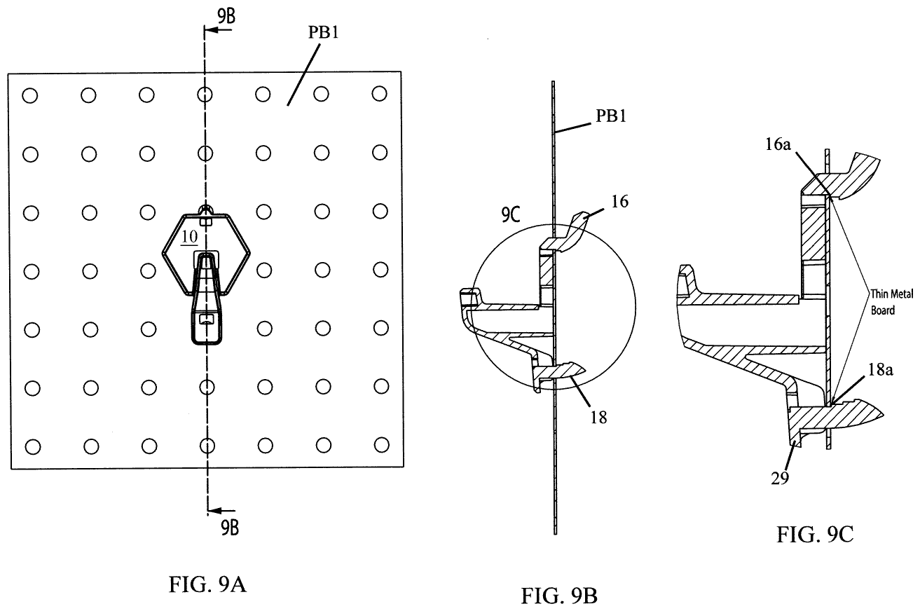

Referring to FIGS. 1-18, the invention will be described in further detail. The holder 10 includes a base 12 from which tabs 16 and 18 extend for attachment to a pegboard. The base 12 may be of different shapes as seen in FIGS. 1-18 depending on the type of tool being held. Extending from the base 12 is a support 14. Support 14 may be of different configurations depending on the type of tool to be held by the support 14 as shown in FIGS. 1-18. The upper inflexible tab 16 extends outwardly and upwardly from the back of base 12 and has one or more detents for engaging the back of a pegboard. Lower flexible tab 18 extends outwardly from the back of base 12 and has one or more detents for engaging the back of a pegboard. Referring to FIGS. 8A-8C, the upper inflexible tab includes two detents 16a and 16b and the lower flexible tab includes three detents 18a, 18b and 18c. These multiple detents allow for pegboard holder 10 to lock into pegboards having different thicknesses as shown in FIGS. 9-11 and discussed below.

Referring to FIGS. 1-11, there is shown a holder 10 comprising a hook for hanging items such as keychains, lanyards, a neck light or the like on the hook. The base 12 includes an upper hexagonal shaped section 20 and a lower square section 22. There is one inflexible tab 16 extending outwardly and upwardly from an upper portion of base 12 and one lower flexible tab extending outwardly from lower square section 22. Support 14 comprises a hook 24 extending outwardly from base 12 and connecting base portions 20 and 22. There is an opening 26 allowing the hook to flex up and down as shown in FIG. 8C. As discussed above, inflexible tab 16 includes locking detents 16a and 16b. Inflexible tab 16 may lock into three different position as shown in FIGS. 9-11 and discussed below. Flexible tab 18 includes three detents 18a, 18b and 18c for locking the holder 10 into pegboards having different thicknesses as shown in FIGS. 9-11 and discussed below. There is a thin area 28 which also allows for flexing of the tool holder. There is a release tab 29 which is pulled outwardly and away from the pegboard to release the tension on one of the detents 18a-18c and to unlock the holder 10 from the pegboard.

Referring to FIGS. 9A-9C, there is shown a pegboard PB1 with holder 10 attached to the pegboard. This pegboard is a thin metal pegboard. The tool holder 10 is inserted in the pegboard by first inserting tab 16 and thereafter inserting tab 18. Detent 16a of tab 16 and detent 18a of tab 18 engage the back of the pegboard to lock the holder in place. To unlock the holder 10 and remove it from the pegboard, release tab 29 of tab 18 is pulled outward and away from the pegboard to release the detents and tension from the pegboard and thereafter remove the holder from the pegboard.

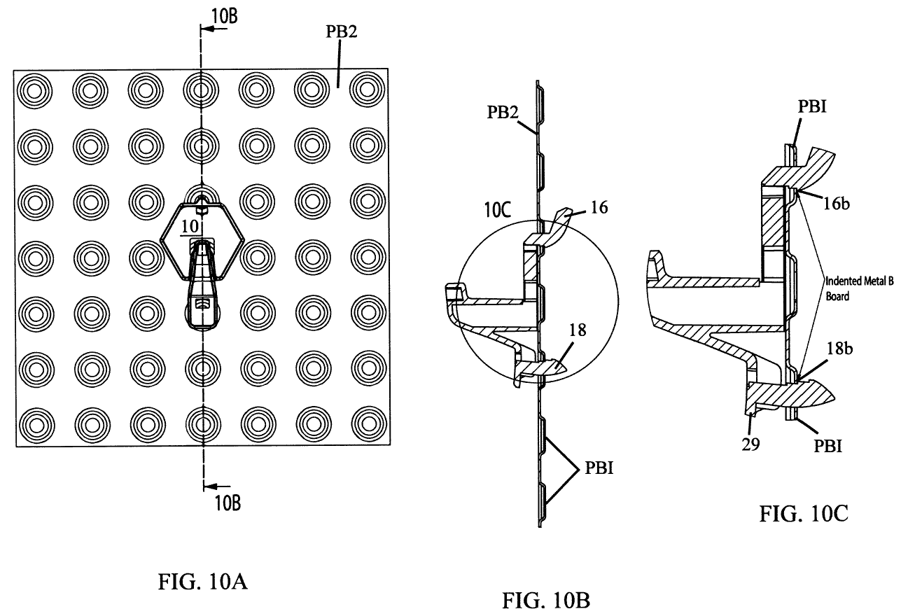

Referring to FIGS. 10A-10C, there is shown an indented metal pegboard PB2 having indentations PBI at the pegboard holes. Holder 10 is inserted through the pegboard holes and because of the different thickness from the pegboard shown in FIG. 9, detent 16b of tab 16 and detent 18b of tab 18 engage the back of the pegboard and lock the holder into place.

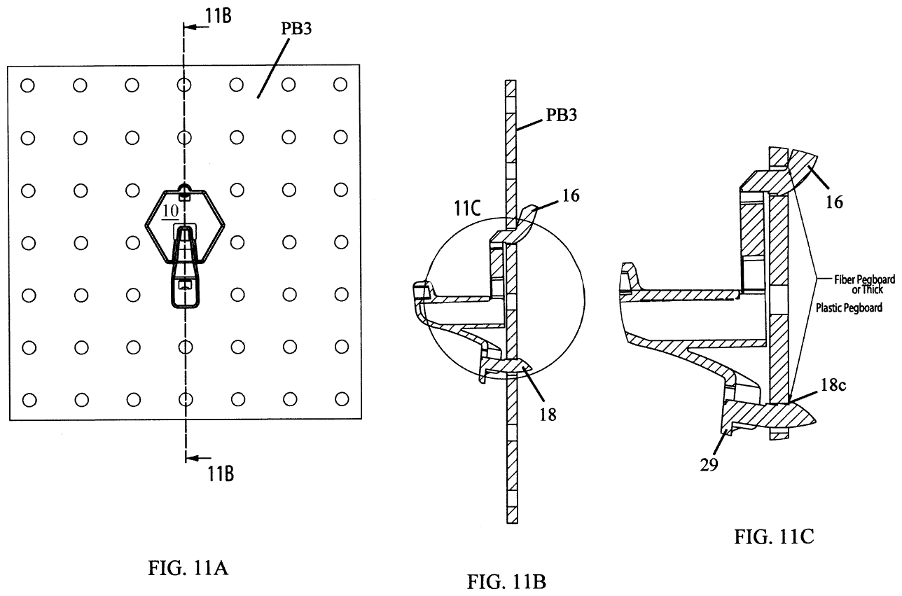

Referring to FIGS. 11A-11C, there is shown a pegboard PB3 comprised of fiber or thick plastic and is thicker than pegboards PB1 and PB2. Holder 10 is inserted through the pegboard holes like in FIGS. 9 and 10. However, due to the thickness, tab 16 bypasses detents 16a and 16b and is held in place by the upper end of tab 16 and tab 18 is locked into position at detent 18c. Holder 10 is removed the same as in FIGS. 9 and 10.

Referring to FIGS. 12A-12G, there is shown a pegboard holder 10A for holding wrenches, in this case ten wrenches. The holder 10A includes two upper inflexible tabs 16 at an upper end of the base 12 and one flexible tab 18 at a lower end of base 12. The holder 10A includes C-shaped openings 30 for receiving a wrench. C-shaped openings 30 include flexible arms 32 and 34 which will open to receive the wrench and compress to hold the wrench in place, the wrench head may seat on the top 36 of the holder. The holder 10A is inserted into a pegboard similar to as shown in FIGS. 9-11.

Referring to FIGS. 13A-13G, there is shown a holder 10B for holding a spray can, bottle or the like. Holder 10B includes two inflexible tabs 16 at an upper end of the base 12 and two flexible tabs 18 at a lower end of base 12. Holder 10B includes an opening 40 for receiving a spray can. The spray can seats on ledge 42 and is held in place by arms 44 and 46. Holder 10B is inserted into a pegboard similar to as shown in FIGS. 9-11.

Referring to FIGS. 14A-14G, there is shown a holder 10C having compartments 50, 52 and 54 for holding pencils, tools or the like. Holder 10C includes two inflexible tabs 16 at an upper end of the base 12 and two flexible tabs 18 at a lower end of base 12. Holder 10C is inserted into a pegboard similar to as shown in FIGS. 9-11.

Referring to FIGS. 15A-15F, there is shown a holder 10D for holding screwdrivers, in this case eighteen screwdrivers. Holder 10D includes four inflexible tabs 16 at an upper end of the base 12 and two flexible tabs 18 at a lower end of base 12. The support 14 includes enlarged openings 60 to receive a screwdriver and smaller openings 62 for the driver to pass through and ring 64 for the screwdriver handle to seat. Holder 10D is inserted into a pegboard similar to as shown in FIGS. 9-11.

Referring to FIGS. 16A-16F, there is shown a holder 10E for holding screwdrivers, in this case nine screwdrivers. Holder 10E is a smaller version of holder 10D. Holder 10E includes two inflexible tabs 16 at an upper end of the base 12 and one flexible tab 18 at a lower end of base 12. Holder 10E is inserted into a pegboard similar to as shown in FIGS. 9-11.

Referring to FIGS. 17A-17G, there is shown a holder 10F for holding a parts tray such as an EZRED® collapsible parts tray. Holder 10F includes two inflexible tabs 16 at an upper end of the base 12 and two flexible tabs 18 at a lower end of base 12. Holder 10F includes a support 14 having an opening 70 adapted to receive a rim of the parts tray and an arm 72 to engage the top of the rim of the parts tray and to hold the parts tray. Holder 10F is inserted into a pegboard similar to as shown in FIGS. 9-11.

Referring to FIGS. 18A-18G, there is shown a holder 10G for holding pliers, a wrench or the like. Holder 10G includes two inflexible tabs 16 at an upper end of the base 12 and two flexible tabs 18 at a lower end of base 12. Support 14 comprises a silicone strap 80 which is held by anchors 82 and 84 of base 12. The strap 80 is held tight against the pegboard and the handle of a pliers is held on each side of the band. A wrench or other tool may be held between the band and the pegboard. Holder 10G is inserted into a peg board similar to as shown in FIGS. 9-11.

Referring to FIG. 19, there is shown the pegboard holders 10A-10G attached to a pegboard.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

1. A pegboard holder comprising a base, a support adapted to hold an item, one or more inflexible tabs extending from an upper portion of a back of the base and adapted to fit into one or more pegboard holes of a pegboard and one or more flexible tabs extending from a lower portion of the base and adapted to fit into another one or more pegboard holes of the pegboard.

2. The pegboard holder of claim 1 wherein the pegboard holder is plastic.

3. The pegboard holder of claim 2 wherein the plastic is ABS.

4. The pegboard holder of claim 1 wherein the one or more inflexible tabs extend outwardly and upwardly from the base and the one or more flexible tabs extend outwardly from the base.

5. The pegboard holder of claim 1 wherein the one or more inflexible tabs and the one or more flexible tabs include one or more detents adapted to allow the pegboard holder to be used with pegboards having different thicknesses.

6. The pegboard holder of claim 5 wherein the one or more inflexible tabs have two detents and the one or more flexible tabs have three detents.

7. The pegboard holder of claim 1 wherein the lower portion of the base includes a release tab adapted to release the one or more flexible tabs from the pegboard.

8. The pegboard holder of claim 1 wherein in the support comprises a means to hold a tool selected from the group consisting of a hook, one or more screw drivers, one or more wrenches, a spray can, a bottle, one or more pliers, a parts tray or a housing having one or more compartments.

9. A plastic pegboard holder comprising a base, a support adapted to hold an item, one or more inflexible tabs extending outwardly and upwardly from an upper portion of a back of the base and adapted to fit into one or more pegboard holes of a pegboard and one or more flexible tabs extending outwardly from a lower portion of the base and adapted to fit into another one or more pegboard holes of the pegboard, wherein the one or more inflexible tabs and the one or more flexible tabs include one or more detents adapted to allow the pegboard holder to be used with pegboards having different thicknesses.

10. The pegboard holder of claim 9 wherein the plastic is ABS.

11. The pegboard holder of claim 9 wherein the one or more inflexible tabs have two detents and the one or more flexible tabs have three detents.

12. The pegboard holder of claim 11 wherein the lower portion of the base includes a release tab adapted to release the one or more flexible tabs from the pegboard.

13. The pegboard holder of claim 12 wherein in the support comprises a means to hold a tool selected from the group consisting of a hook, one or more screw drivers, one or more wrenches, a spray can, a bottle, one or more pliers, a parts tray or a housing having one or more compartments.

14. A method of inserting a pegboard holder into a pegboard comprising the steps of
a. providing a pegboard having a plurality of pegboard holes;
b. providing a plastic pegboard holder comprising a base, a support adapted to hold an item, one or more inflexible tabs extending outwardly and upwardly from an upper portion of a back of the base and adapted to fit into one or more of the pegboard holes of the pegboard and one or more flexible tabs extending from a lower portion of the base and adapted to fit into another one or more of the pegboard holes of the pegboard, wherein the one or more inflexible tabs and the one or more flexible tabs include one or more detents adapted to allow the pegboard holder to be used with pegboards having different thicknesses;
c. inserting the one or more inflexible tabs into the one or more of the pegboard holes;
d. inserting the one or more inflexible tabs into the another of the one or more pegboard holes and locking the pegboard holder into the pegboard.

15. The method of claim 14 wherein the plastic is ABS.

16. The pegboard holder of claim 14 wherein the one or more inflexible tabs have two detents and the one or more flexible tabs have three detents.

17. The method of claim 16 wherein the lower portion of the base includes a release tab adapted to release the one or more flexible tabs from the pegboard.

18. The method of claim 17 wherein in the support comprises a means to hold a tool selected from the group consisting of a hook, one or more screw drivers, one or more wrenches, a spray can, a bottle, one or more pliers, a parts tray or a housing having one or more compartments.
